(19) United States
(12) Patent Application Publication
(10) Pub. No.: US 2025/0148353 A1
(43) Pub. Date: May 8, 2025

(54) Method, System, and Computer Program Product for Machine Learning Using Decoupled Knowledge Graphs

(71) Applicant: Visa International Service Association, San Francisco, CA (US)

(72) Inventors: Xi Kan, Austin, TX (US); Juncheng Ding, Leander, TX (US); Dan Wang, Cedar Park, TX (US)

(21) Appl. No.: 18/502,361

(22) Filed: Nov. 6, 2023

(51) Int. Cl. G06N 20/00; G06N 5/02

(52) U.S. Cl. CPC G06N 20/00; G06N 5/02

(57) ABSTRACT

Described are a method, system, and computer program product for machine learning using decoupled knowledge graphs. The method includes generating a graph including nodes connected by edges based on data of entities in a network. Generating the graph includes generating entity nodes, determining a distribution of values for an attribute of the entities, generating a lower attribute node associated with a lower subset of values for the attribute, generating a higher attribute node associated with a higher subset of values for the attribute, and generating edges connecting the nodes. The method also includes initializing node embeddings, and generating representations of the nodes by repeating, until convergence, updating the embeddings of the entity nodes while holding other embeddings static, and updating the embeddings of the non-entity nodes while holding other embeddings static. The method further includes executing a machine learning model using the representations.

### BACKGROUND

### 1. Technical Field

This disclosure relates generally to machine learning and, in non-limiting embodiments or aspects, to methods, systems, and computer program products for machine learning using decoupled knowledge graphs.

### 2. Technical Considerations

Knowledge graphs are useful for machine learning, in that relationships between entities in a network may be represented by edges connecting nodes in the knowledge graph. These knowledge graphs may be useful for learning relationships and behaviors of entities in a network, but technical complications may arise for training, using, or updating these knowledge graphs. For example, during an initial training, computational resource load (e.g., memory, bandwidth, processing capacity, etc.) may be high, given that embeddings for all nodes in a knowledge graph are trained at the same time. Moreover, attributes for an entity may be represented in the same node as the entity, raising the complexity of embeddings for individual nodes in the knowledge graph. Furthermore, if there is an update to the network (e.g., a node is added, a node is removed, values of attributes drift over time, etc.), then the entire knowledge graph may be retrained, and retraining may be needed more frequently. Each update may require a large memory load to update all embeddings in the knowledge graph.

There is a need in the art for a technical solution that uses knowledge graphs more efficiently in machine learning, particularly to decrease computational resource load during training, use, and updating of the knowledge graphs.

### SUMMARY

According to some non-limiting embodiments or aspects, provided are methods, systems, and computer program products for machine learning using decoupled knowledge graphs that overcome some or all of the deficiencies identified above.

According to some non-limiting embodiments or aspects, provided is a method for machine learning using decoupled knowledge graphs. The method includes generating, with at least one processor, a knowledge graph including a plurality of nodes connected by a plurality of edges, based on transaction data of a plurality of entities in a network. Generating the knowledge graph includes generating a plurality of entity nodes of the plurality of nodes, each entity node of the plurality of entity nodes associated with an entity of the plurality of entities. Generating the knowledge graph also includes determining a distribution of values for at least one attribute of the plurality of entities in the network, based on the transaction data. Generating the knowledge graph further includes generating at least one lower attribute node of the plurality of nodes associated with a lower subset of values for the at least one attribute, based on the distribution of values. Generating the knowledge graph further includes generating at least one higher attribute node of the plurality of nodes associated with a higher subset of values for the at least one attribute, based on the distribution of values. Generating the knowledge graph further includes generating the plurality of edges, each edge of the plurality of edges connecting two nodes of the plurality of nodes and being associated with a relationship between the two nodes. The method also includes initializing, with at least one processor, embeddings associated with the plurality of nodes with random values. The method further includes generating, with at least one processor, learned representations of the plurality of nodes by repeatedly updating the embeddings associated with the plurality of nodes. Repeatedly updating the embeddings includes, until convergence of the embeddings on the learned representations, updating the embeddings of the plurality of entity nodes while holding the embeddings of a plurality of non-entity nodes of the plurality of nodes static, the plurality of non-entity nodes including a set of the plurality of nodes exclusive of the plurality of entity nodes, and updating the embeddings of the plurality of non-entity nodes while holding the embeddings of the plurality of entity nodes static. The method further includes executing, with at least one processor, at least one classification machine learning model using the learned representations of the plurality of nodes.

In some non-limiting embodiments or aspects, updating the embeddings of the plurality of entity nodes may include updating an embedding of each entity node of the plurality of entity nodes using an aggregation technique to identify a value of entity nodes in a k-step neighborhood associated with the entity node. Updating the embeddings of the plurality of non-entity nodes may include updating an embedding of each non-entity node of the plurality of non-entity nodes using the aggregation technique to identify a value of non-entity nodes in a k-step neighborhood associated with the non-entity node.

In some non-limiting embodiments or aspects, the aggregation technique may be a pool aggregation technique. The pool aggregation technique may identify a maximum value of nodes in a k-step neighborhood associated with a node.

In some non-limiting embodiments or aspects, the aggregation technique may be a mean aggregation technique. The mean aggregation technique may identify a mean value of nodes in a k-step neighborhood associated with a node.

In some non-limiting embodiments or aspects, the method may further include a series of steps in response to a new entity being added to the network. The series of steps may include generating, with at least one processor, a new entity node of the plurality of nodes of the knowledge graph associated with the new entity. The series of steps may also include generating, with at least one processor, at least one new edge of the plurality of edges of the knowledge graph, wherein the at least one new edge connects the new entity node to at least one other node of the plurality of nodes. The series of steps may further include generating, with at least one processor, a default embedding for the new entity node. The series of steps may further include updating, with at least one processor, the embedding of the new entity node while holding the embeddings of the plurality of non-entity nodes static. Updating the embedding of the new entity node may include updating the embedding of the new entity node using the aggregation technique to identify a value of entity nodes in a k-step neighborhood associated with the new entity node. The series of steps may further include re-executing, with at least one processor, the at least one classification machine learning model based at least partially on the updated embedding of the new entity node.

In some non-limiting embodiments or aspects, the method may include a series of steps in response to an entity being removed from the network. The series of steps may include removing, with at least one processor, a first entity node from the knowledge graph associated with the entity removed from the network. The series of steps may also include identifying, with at least one processor, a second entity node previously connected to the first entity node in the knowledge graph. The series of steps may further include updating, with at least one processor, an embedding of the second entity node while holding the embeddings of the plurality of non-entity nodes static. Updating the embedding of the second entity node may include updating the embedding of the second entity node using the aggregation technique to identify a value of entity nodes in a k-step neighborhood associated with the second entity node. The series of steps may further include re-executing, with at least one processor, the at least one classification machine learning model based at least partially on the updated embedding of the second entity node.

In some non-limiting embodiments or aspects, generating the knowledge graph may further include generating at least one middle attribute node of the plurality of nodes associated with a middle subset of values for the at least one attribute, based on the distribution of values. Each entity node of the plurality of entity nodes may be connected, for each attribute of the at least one attribute, to a lower attribute node, a middle attribute node, or a higher attribute node for the attribute, based on the transaction data.

According to some non-limiting embodiments or aspects, provided is a system for machine learning using decoupled knowledge graphs. The system includes at least one processor programmed or configured to generate a knowledge graph including a plurality of nodes connected by a plurality of edges, based on transaction data of a plurality of entities in a network. When generating the knowledge graph, the at least one processor is programmed or configured to generate a plurality of entity nodes of the plurality of nodes, each entity node of the plurality of entity nodes associated with an entity of the plurality of entities. When generating the knowledge graph, the at least one processor is also programmed or configured to determine a distribution of values for at least one attribute of the plurality of entities in the network, based on the transaction data. When generating the knowledge graph, the at least one processor is further programmed or configured to generate at least one lower attribute node of the plurality of nodes associated with a lower subset of values for the at least one attribute, based on the distribution of values. When generating the knowledge graph, the at least one processor is further programmed or configured to generate at least one higher attribute node of the plurality of nodes associated with a higher subset of values for the at least one attribute, based on the distribution of values. When generating the knowledge graph, the at least one processor is further programmed or configured to generate the plurality of edges, each edge of the plurality of edges connecting two nodes of the plurality of nodes and being associated with a relationship between the two nodes. The at least one processor is also programmed or configured to initialize embeddings associated with the plurality of nodes with random values. The at least one processor is further programmed or configured to generate learned representations of the plurality of nodes by repeatedly updating the embeddings associated with the plurality of nodes. When repeatedly updating the embeddings, the at least one processor is programmed or configured to, until convergence of the embeddings on the learned representations, update the embeddings of the plurality of entity nodes while holding the embeddings of a plurality of non-entity nodes of the plurality of nodes static, the plurality of non-entity nodes including a set of the plurality of nodes exclusive of the plurality of entity nodes, and update the embeddings of the plurality of non-entity nodes while holding the embeddings of the plurality of entity nodes static. The at least one processor is further programmed or configured to execute at least one classification machine learning model using the learned representations of the plurality of nodes.

In some non-limiting embodiments or aspects, when updating the embeddings of the plurality of entity nodes, the at least one processor may be programmed or configured to update an embedding of each entity node of the plurality of entity nodes using an aggregation technique to identify a value of entity nodes in a k-step neighborhood associated with the entity node. When updating the embeddings of the plurality of non-entity nodes, the at least one processor may be programmed or configured to update an embedding of each non-entity node of the plurality of non-entity nodes using the aggregation technique to identify a value of non-entity nodes in a k-step neighborhood associated with the non-entity node.

In some non-limiting embodiments or aspects, the aggregation technique may be a pool aggregation technique. The pool aggregation technique may identify a maximum value of nodes in a k-step neighborhood associated with a node.

In some non-limiting embodiments or aspects, the aggregation technique may be a mean aggregation technique. The mean aggregation technique may identify a mean value of nodes in a k-step neighborhood associated with a node.

In some non-limiting embodiments or aspects, the at least one processor may be further programmed or configured to, in response to a new entity being added to the network, execute a series of steps. The series of steps may include generating a new entity node of the plurality of nodes of the knowledge graph associated with the new entity. The series of steps may also include generating at least one new edge of the plurality of edges of the knowledge graph, wherein the at least one new edge connects the new entity node to at least one other node of the plurality of nodes. The series of steps may further include generating a default embedding for the new entity node and updating the embedding of the new entity node while holding the embeddings of the plurality of non-entity nodes static. When updating the embedding of the new entity node, the at least one processor may be programmed or configured to update the embedding of the new entity node using the aggregation technique to identify a value of entity nodes in a k-step neighborhood associated with the new entity node. The series of steps may further include re-executing the at least one classification machine learning model based at least partially on the updated embedding of the new entity node.

In some non-limiting embodiments or aspects, the at least one processor may be further programmed or configured to, in response to an entity being removed from the network, execute a series of steps. The series of steps may include removing a first entity node from the knowledge graph associated with the entity removed from the network. The series of steps may also include identifying a second entity node previously connected to the first entity node in the knowledge graph. The series of steps may further include updating an embedding of the second entity node while holding the embeddings of the plurality of non-entity nodes static. When updating the embedding of the second entity node, the at least one processor may be programmed or configured to update the embedding of the second entity node using the aggregation technique to identify a value of entity nodes in a k-step neighborhood associated with the second entity node. The series of steps may further include re-executing the at least one classification machine learning model based at least partially on the updated embedding of the second entity node.

In some non-limiting embodiments or aspects, when generating the knowledge graph, the at least one processor may be further programmed or configured to generate at least one middle attribute node of the plurality of nodes associated with a middle subset of values for the at least one attribute, based on the distribution of values. Each entity node of the plurality of entity nodes may be connected, for each attribute of the at least one attribute, to a lower attribute node, a middle attribute node, or a higher attribute node for the attribute, based on the transaction data.

According to some non-limiting embodiments or aspects, provided is a computer program product for machine learning using decoupled knowledge graphs. The computer program product includes at least one non-transitory computer-readable medium including one or more instructions. The one or more instructions, when executed by at least one processor, cause the at least one processor to generate a knowledge graph including a plurality of nodes connected by a plurality of edges, based on transaction data of a plurality of entities in a network. When generating the knowledge graph, the one or more instructions cause the at least one processor to generate a plurality of entity nodes of the plurality of nodes, each entity node of the plurality of entity nodes associated with an entity of the plurality of entities. When generating the knowledge graph, the one or more instructions also cause the at least one processor to determine a distribution of values for at least one attribute of the plurality of entities in the network, based on the transaction data. When generating the knowledge graph, the one or more instructions further cause the at least one processor to generate at least one lower attribute node of the plurality of nodes associated with a lower subset of values for the at least one attribute, based on the distribution of values. When generating the knowledge graph, the one or more instructions further cause the at least one processor to generate at least one higher attribute node of the plurality of nodes associated with a higher subset of values for the at least one attribute, based on the distribution of values. When generating the knowledge graph, the one or more instructions further cause the at least one processor to generate the plurality of edges, each edge of the plurality of edges connecting two nodes of the plurality of nodes and being associated with a relationship between the two nodes. The one or more instructions also cause the at least one processor to initialize embeddings associated with the plurality of nodes with random values. The one or more instruction further cause the at least one processor to generate learned representations of the plurality of nodes by repeatedly updating the embeddings associated with the plurality of nodes. The one or more instructions that cause the at least one processor to repeatedly update the embeddings cause the at least one processor to, until convergence of the embeddings on the learned representations, update the embeddings of the plurality of entity nodes while holding the embeddings of a plurality of non-entity nodes of the plurality of nodes static, the plurality of non-entity nodes including a set of the plurality of nodes exclusive of the plurality of entity nodes, and update the embeddings of the plurality of non-entity nodes while holding the embeddings of the plurality of entity nodes static. The one or more instructions further cause the at least one processor to execute at least one classification machine learning model using the learned representations of the plurality of nodes.

In some non-limiting embodiments or aspects, the one or more instructions that cause the at least one processor to update the embeddings of the plurality of entity nodes may cause the at least one processor to update an embedding of each entity node of the plurality of entity nodes using an aggregation technique to identify a value of entity nodes in a k-step neighborhood associated with the entity node. The one or more instructions that cause the at least one processor to update the embeddings of the plurality of non-entity nodes cause the at least one processor to update an embedding of each non-entity node of the plurality of non-entity nodes using the aggregation technique to identify a value of non-entity nodes in a k-step neighborhood associated with the non-entity node.

In some non-limiting embodiments or aspects, the aggregation technique may be a pool aggregation technique. The pool aggregation technique may identify a maximum value of nodes in a k-step neighborhood associated with a node.

In some non-limiting embodiments or aspects, the aggregation technique may be a mean aggregation technique. The mean aggregation technique may identify a mean value of nodes in a k-step neighborhood associated with a node.

In some non-limiting embodiments or aspects, the one or more instructions may further cause the at least one processor to, in response to a new entity being added to the network, execute a series of steps. The series of steps may include generating a new entity node of the plurality of nodes of the knowledge graph associated with the new entity. The series of steps may also include generating at least one new edge of the plurality of edges of the knowledge graph, wherein the at least one new edge connects the new entity node to at least one other node of the plurality of nodes. The series of steps may further include generating a default embedding for the new entity node. The series of steps may further include updating the embedding of the new entity node while holding the embeddings of the plurality of non-entity nodes static. The one or more instructions that cause the at least one processor to update the embedding of the new entity node may cause the at least one processor to update the embedding of the new entity node using the aggregation technique to identify a value of entity nodes in a k-step neighborhood associated with the new entity node. The series of steps may further include re-executing the at least one classification machine learning model based at least partially on the updated embedding of the new entity node.

In some non-limiting embodiments or aspects, the one or more instructions may further cause the at least one processor to, in response to an entity being removed from the network, execute a series of steps. The series of steps may include removing a first entity node from the knowledge graph associated with the entity removed from the network. The series of steps may also include identifying a second entity node previously connected to the first entity node in the knowledge graph. The series of steps may further include updating an embedding of the second entity node while holding the embeddings of the plurality of non-entity nodes static. The one or more instructions that cause the at least one processor to update the embedding of the second entity node may cause the at least one processor to update the embedding of the second entity node using the aggregation technique to identify a value of entity nodes in a k-step neighborhood associated with the second entity node. The series of steps may further include re-executing the at least one classification machine learning model based at least partially on the updated embedding of the second entity node.

Other non-limiting embodiments or aspects will be set forth in the following numbered clauses:

Clause 1: A method comprising: generating, with at least one processor, a knowledge graph comprising a plurality of nodes connected by a plurality of edges, based on transaction data of a plurality of entities in a network, wherein generating the knowledge graph comprises: generating a plurality of entity nodes of the plurality of nodes, each entity node of the plurality of entity nodes associated with an entity of the plurality of entities; determining a distribution of values for at least one attribute of the plurality of entities in the network, based on the transaction data; generating at least one lower attribute node of the plurality of nodes associated with a lower subset of values for the at least one attribute, based on the distribution of values; generating at least one higher attribute node of the plurality of nodes associated with a higher subset of values for the at least one attribute, based on the distribution of values; and generating the plurality of edges, each edge of the plurality of edges connecting two nodes of the plurality of nodes and being associated with a relationship between the two nodes; initializing, with at least one processor, embeddings associated with the plurality of nodes with random values; generating, with at least one processor, learned representations of the plurality of nodes by repeatedly updating the embeddings associated with the plurality of nodes, wherein repeatedly updating the embeddings comprises, until convergence of the embeddings on the learned representations: updating the embeddings of the plurality of entity nodes while holding the embeddings of a plurality of non-entity nodes of the plurality of nodes static, the plurality of non-entity nodes comprising a set of the plurality of nodes exclusive of the plurality of entity nodes; and updating the embeddings of the plurality of non-entity nodes while holding the embeddings of the plurality of entity nodes static; and executing, with at least one processor, at least one classification machine learning model using the learned representations of the plurality of nodes.

Clause 2: The method of clause 1, wherein updating the embeddings of the plurality of entity nodes comprises: updating an embedding of each entity node of the plurality of entity nodes using an aggregation technique to identify a value of entity nodes in a k-step neighborhood associated with the entity node; and wherein updating the embeddings of the plurality of non-entity nodes comprises: updating an embedding of each non-entity node of the plurality of non-entity nodes using the aggregation technique to identify a value of non-entity nodes in a k-step neighborhood associated with the non-entity node.

Clause 3: The method of clause 1 or clause 2, wherein the aggregation technique is a pool aggregation technique, and wherein the pool aggregation technique identifies a maximum value of nodes in a k-step neighborhood associated with a node.

Clause 4: The method of clause 1 or clause 2, wherein the aggregation technique is a mean aggregation technique, and wherein the mean aggregation technique identifies a mean value of nodes in a k-step neighborhood associated with a node.

Clause 5: The method of any of clauses 1-4, further comprising, in response to a new entity being added to the network: generating, with at least one processor, a new entity node of the plurality of nodes of the knowledge graph associated with the new entity; generating, with at least one processor, at least one new edge of the plurality of edges of the knowledge graph, wherein the at least one new edge connects the new entity node to at least one other node of the plurality of nodes; generating, with at least one processor, a default embedding for the new entity node; updating, with at least one processor, the embedding of the new entity node while holding the embeddings of the plurality of non-entity nodes static, wherein updating the embedding of the new entity node comprises: updating the embedding of the new entity node using the aggregation technique to identify a value of entity nodes in a k-step neighborhood associated with the new entity node; and re-executing, with at least one processor, the at least one classification machine learning model based at least partially on the updated embedding of the new entity node.

Clause 6: The method of any of clauses 1-5, further comprising, in response to an entity being removed from the network: removing, with at least one processor, a first entity node from the knowledge graph associated with the entity removed from the network; identifying, with at least one processor, a second entity node previously connected to the first entity node in the knowledge graph; updating, with at least one processor, an embedding of the second entity node while holding the embeddings of the plurality of non-entity nodes static, wherein updating the embedding of the second entity node comprises: updating the embedding of the second entity node using the aggregation technique to identify a value of entity nodes in a k-step neighborhood associated with the second entity node; and re-executing, with at least one processor, the at least one classification machine learning model based at least partially on the updated embedding of the second entity node.

Clause 7: The method of any of clauses 1-6, wherein generating the knowledge graph further comprises: generating at least one middle attribute node of the plurality of nodes associated with a middle subset of values for the at least one attribute, based on the distribution of values; and wherein each entity node of the plurality of entity nodes is connected, for each attribute of the at least one attribute, to a lower attribute node, a middle attribute node, or a higher attribute node for the attribute, based on the transaction data.

Clause 8: A system comprising at least one processor programmed or configured to: generate a knowledge graph comprising a plurality of nodes connected by a plurality of edges, based on transaction data of a plurality of entities in a network, wherein, when generating the knowledge graph, the at least one processor is programmed or configured to: generate a plurality of entity nodes of the plurality of nodes, each entity node of the plurality of entity nodes associated with an entity of the plurality of entities; determine a distribution of values for at least one attribute of the plurality of entities in the network, based on the transaction data; generate at least one lower attribute node of the plurality of nodes associated with a lower subset of values for the at least one attribute, based on the distribution of values; generate at least one higher attribute node of the plurality of nodes associated with a higher subset of values for the at least one attribute, based on the distribution of values; and generate the plurality of edges, each edge of the plurality of edges connecting two nodes of the plurality of nodes and being associated with a relationship between the two nodes; initialize embeddings associated with the plurality of nodes with random values; generate learned representations of the plurality of nodes by repeatedly updating the embeddings associated with the plurality of nodes, wherein, when repeatedly updating the embeddings, the at least one processor is programmed or configured to, until convergence of the embeddings on the learned representations: update the embeddings of the plurality of entity nodes while holding the embeddings of a plurality of non-entity nodes of the plurality of nodes static, the plurality of non-entity nodes comprising a set of the plurality of nodes exclusive of the plurality of entity nodes; and update the embeddings of the plurality of non-entity nodes while holding the embeddings of the plurality of entity nodes static; and execute at least one classification machine learning model using the learned representations of the plurality of nodes.

Clause 9: The system of clause 8, wherein, when updating the embeddings of the plurality of entity nodes, the at least one processor is programmed or configured to: update an embedding of each entity node of the plurality of entity nodes using an aggregation technique to identify a value of entity nodes in a k-step neighborhood associated with the entity node; and wherein, when updating the embeddings of the plurality of non-entity nodes, the at least one processor is programmed or configured to: update an embedding of each non-entity node of the plurality of non-entity nodes using the aggregation technique to identify a value of non-entity nodes in a k-step neighborhood associated with the non-entity node.

Clause 10: The system of clause 8 or clause 9, wherein the aggregation technique is a pool aggregation technique, and wherein the pool aggregation technique identifies a maximum value of nodes in a k-step neighborhood associated with a node.

Clause 11: The system of clause 8 or clause 9, wherein the aggregation technique is a mean aggregation technique, and wherein the mean aggregation technique identifies a mean value of nodes in a k-step neighborhood associated with a node.

Clause 12: The system of any of clauses 8-11, wherein the at least one processor is further programmed or configured to, in response to a new entity being added to the network: generate a new entity node of the plurality of nodes of the knowledge graph associated with the new entity; generate at least one new edge of the plurality of edges of the knowledge graph, wherein the at least one new edge connects the new entity node to at least one other node of the plurality of nodes; generate a default embedding for the new entity node; update the embedding of the new entity node while holding the embeddings of the plurality of non-entity nodes static, wherein, when updating the embedding of the new entity node, the at least one processor is programmed or configured to: update the embedding of the new entity node using the aggregation technique to identify a value of entity nodes in a k-step neighborhood associated with the new entity node; and re-execute the at least one classification machine learning model based at least partially on the updated embedding of the new entity node.

Clause 13: The system of any of clauses 8-12, wherein the at least one processor is further programmed or configured to, in response to an entity being removed from the network: remove a first entity node from the knowledge graph associated with the entity removed from the network; identify a second entity node previously connected to the first entity node in the knowledge graph; update an embedding of the second entity node while holding the embeddings of the plurality of non-entity nodes static, wherein, when updating the embedding of the second entity node, the at least one processor is programmed or configured to: update the embedding of the second entity node using the aggregation technique to identify a value of entity nodes in a k-step neighborhood associated with the second entity node; and re-execute the at least one classification machine learning model based at least partially on the updated embedding of the second entity node.

Clause 14: The system of any of clauses 8-13, wherein, when generating the knowledge graph, the at least one processor is further programmed or configured to: generate at least one middle attribute node of the plurality of nodes associated with a middle subset of values for the at least one attribute, based on the distribution of values; and wherein each entity node of the plurality of entity nodes is connected, for each attribute of the at least one attribute, to a lower attribute node, a middle attribute node, or a higher attribute node for the attribute, based on the transaction data.

Clause 15: A computer program product comprising at least one non-transitory computer-readable medium comprising one or more instructions that, when executed by at least one processor, cause the at least one processor to: generate a knowledge graph comprising a plurality of nodes connected by a plurality of edges, based on transaction data of a plurality of entities in a network, wherein the one or more instructions that cause the at least one processor to generate the knowledge graph cause the at least one processor to: generate a plurality of entity nodes of the plurality of nodes, each entity node of the plurality of entity nodes associated with an entity of the plurality of entities; determine a distribution of values for at least one attribute of the plurality of entities in the network, based on the transaction data; generate at least one lower attribute node of the plurality of nodes associated with a lower subset of values for the at least one attribute, based on the distribution of values; generate at least one higher attribute node of the plurality of nodes associated with a higher subset of values for the at least one attribute, based on the distribution of values; and generate the plurality of edges, each edge of the plurality of edges connecting two nodes of the plurality of nodes and being associated with a relationship between the two nodes; initialize embeddings associated with the plurality of nodes with random values; generate learned representations of the plurality of nodes by repeatedly updating the embeddings associated with the plurality of nodes, wherein the one or more instructions that cause the at least one processor to repeatedly update the embeddings cause the at least one processor to, until convergence of the embeddings on the learned representations: update the embeddings of the plurality of entity nodes while holding the embeddings of a plurality of non-entity nodes of the plurality of nodes static, the plurality of non-entity nodes comprising a set of the plurality of nodes exclusive of the plurality of entity nodes; and update the embeddings of the plurality of non-entity nodes while holding the embeddings of the plurality of entity nodes static; and execute at least one classification machine learning model using the learned representations of the plurality of nodes.

Clause 16: The computer program product of clause 15, wherein the one or more instructions that cause the at least one processor to update the embeddings of the plurality of entity nodes cause the at least one processor to: update an embedding of each entity node of the plurality of entity nodes using an aggregation technique to identify a value of entity nodes in a k-step neighborhood associated with the entity node; and wherein the one or more instructions that cause the at least one processor to update the embeddings of the plurality of non-entity nodes cause the at least one processor to: update an embedding of each non-entity node of the plurality of non-entity nodes using the aggregation technique to identify a value of non-entity nodes in a k-step neighborhood associated with the non-entity node.

Clause 17: The computer program product of clause 15 or clause 16, wherein the aggregation technique is a pool aggregation technique, and wherein the pool aggregation technique identifies a maximum value of nodes in a k-step neighborhood associated with a node.

Clause 18: The computer program product of clause 15 or clause 16, wherein the aggregation technique is a mean aggregation technique, and wherein the mean aggregation technique identifies a mean value of nodes in a k-step neighborhood associated with a node.

Clause 19: The computer program product of any of clauses 15-18, wherein the one or more instructions further cause the at least one processor to, in response to a new entity being added to the network: generate a new entity node of the plurality of nodes of the knowledge graph associated with the new entity; generate at least one new edge of the plurality of edges of the knowledge graph, wherein the at least one new edge connects the new entity node to at least one other node of the plurality of nodes; generate a default embedding for the new entity node; update the embedding of the new entity node while holding the embeddings of the plurality of non-entity nodes static, wherein the one or more instructions that cause the at least one processor to update the embedding of the new entity node cause the at least one processor to: update the embedding of the new entity node using the aggregation technique to identify a value of entity nodes in a k-step neighborhood associated with the new entity node; and re-execute the at least one classification machine learning model based at least partially on the updated embedding of the new entity node.

Clause 20: The computer program product of any of clauses 15-19, wherein the one or more instructions further cause the at least one processor to, in response to an entity being removed from the network: remove a first entity node from the knowledge graph associated with the entity removed from the network; identify a second entity node previously connected to the first entity node in the knowledge graph; update an embedding of the second entity node while holding the embeddings of the plurality of non-entity nodes static, wherein the one or more instructions that cause the at least one processor to update the embedding of the second entity node cause the at least one processor to: update the embedding of the second entity node using the aggregation technique to identify a value of entity nodes in a k-step neighborhood associated with the second entity node; and re-execute the at least one classification machine learning model based at least partially on the updated embedding of the second entity node.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure. As used in the specification and the claims, the singular form of “a,” “an,” and “the” include plural referents unless the context clearly dictates otherwise.

### BRIEF DESCRIPTION OF THE DRAWINGS

Additional advantages and details of the disclosure are explained in greater detail below with reference to the exemplary embodiments or aspects that are illustrated in the accompanying schematic figures, in which:

FIG. 1 is a diagram of a non-limiting embodiment or aspect of an environment in which systems, devices, products, apparatus, and/or methods, described herein, may be implemented, according to the principles of the present disclosure;

FIG. 2 is a diagram of one or more components, devices, and/or systems, according to some non-limiting embodiments or aspects;

FIG. 3 is a flowchart of a method for machine learning using decoupled knowledge graphs, according to some non-limiting embodiments or aspects;

FIG. 4 is a flowchart of a method for machine learning using decoupled knowledge graphs, according to some non-limiting embodiments or aspects;

FIG. 5 is a flowchart of a method for machine learning using decoupled knowledge graphs, according to some non-limiting embodiments or aspects; and

FIG. 6 is an exemplary decoupled knowledge graph for use in machine learning, according to some non-limiting embodiments or aspects.

### DETAILED DESCRIPTION

For purposes of the description hereinafter, the terms “upper”, “lower”, “right”, “left”, “vertical”, “horizontal”, “top”, “bottom”, “lateral”, “longitudinal,” and derivatives thereof shall relate to non-limiting embodiments or aspects as they are oriented in the drawing figures. However, it is to be understood that non-limiting embodiments or aspects may assume various alternative variations and step sequences, except where expressly specified to the contrary. It is also to be understood that the specific devices and processes illustrated in the attached drawings, and described in the following specification, are simply exemplary embodiments or aspects. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. The phase “based on” may also mean “in response to” where appropriate.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments or aspects, an acquirer institution may be a financial institution, such as a bank. As used herein, the term “acquirer system” may refer to one or more computing devices operated by or on behalf of an acquirer institution, such as a server computer executing one or more software applications.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the terms “electronic wallet” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as Google Pay®, Android Pay®, Apple Pay®, Samsung Pay®, and/or other like electronic payment systems. In some non-limiting examples, an issuer bank may be an electronic wallet provider.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a PAN, to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications.

As used herein, a “point-of-sale (POS) device” may refer to one or more devices, which may be used by a merchant to conduct a transaction (e.g., a payment transaction) and/or process a transaction. For example, a POS device may include one or more client devices. Additionally or alternatively, a POS device may include peripheral devices, card readers, scanning devices (e.g., code scanners), Bluetooth® communication receivers, near-field communication (NFC) receivers, radio frequency identification (RFID) receivers, and/or other contactless transceivers or receivers, contact-based receivers, payment terminals, and/or the like. As used herein, a “point-of-sale (POS) system” may refer to one or more client devices and/or peripheral devices used by a merchant to conduct a transaction. For example, a POS system may include one or more POS devices and/or other like devices that may be used to conduct a payment transaction. In some non-limiting embodiments or aspects, a POS system (e.g., a merchant POS system) may include one or more server computers programmed or configured to process online payment transactions through webpages, mobile applications, and/or the like.

As used herein, the terms “client” and “client device” may refer to one or more client-side devices or systems (e.g., remote from a transaction service provider) used to initiate or facilitate a transaction (e.g., a payment transaction). As an example, a “client device” may refer to one or more POS devices used by a merchant, one or more acquirer host computers used by an acquirer, one or more mobile devices used by a user, one or more computing devices used by a payment device provider system, and/or the like. In some non-limiting embodiments or aspects, a client device may be an electronic device configured to communicate with one or more networks and initiate or facilitate transactions. For example, a client device may include one or more computers, portable computers, laptop computers, tablet computers, mobile devices, cellular phones, wearable devices (e.g., watches, glasses, lenses, clothing, and/or the like), PDAs, and/or the like. Moreover, a “client” may also refer to an entity (e.g., a merchant, an acquirer, and/or the like) that owns, utilizes, and/or operates a client device for initiating transactions (e.g., for initiating transactions with a transaction service provider).

As used herein, the term “payment device” may refer to a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a PDA, a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “server” may refer to or include one or more computing devices that are operated by or facilitate communication and processing for multiple parties in a network environment, such as the internet, although it will be appreciated that communication may be facilitated over one or more public or private network environments and that various other arrangements are possible. Further, multiple computing devices (e.g., servers, POS devices, mobile devices, etc.) directly or indirectly communicating in the network environment may constitute a “system.” Reference to “a server” or “a processor,” as used herein, may refer to a previously recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

The methods, systems, and computer program products described herein provide numerous technical advantages in systems for machine learning. First, the disclosed systems and methods improve the computational efficiency of machine learning using knowledge graphs by generating a decoupled knowledge graph instead of using a unitary knowledge graph where each node represents both entities and their attributes. By having some nodes for entities and some nodes for non-entities (e.g., associated with attributes and their ranges), knowledge graphs may provide more accurate machine learning classifications even for entities with limited attributes or attribute data. Moreover, the decoupled knowledge graph allows learned representations of embeddings for entity nodes and non-entity nodes to be generated and regenerated separately, which reduces computational load (e.g., memory, bandwidth, processing capacity) at the time of training and updating. For example, instead of executing a global update for a knowledge graph when nodes are added, removed, or modified, the knowledge graph may be updated in a decoupled manner (e.g., updating embeddings of entity nodes while holding non-entity nodes static, and vice versa).

By way of further example, when an entity is added to a network, the disclosed systems and methods allow for rapid and computationally efficient generation of a new embedding for the new entity node by running a local update (e.g., of a neighborhood of nodes, of a same type of nodes, etc.) based on a default embedding of the new entity node. Similarly, when an entity is removed from a network, the disclosed systems and methods allow for rapid and computationally efficient updating of the knowledge graph, by identifying formerly connected nodes and running a local update (e.g., of a neighborhood of nodes, of a same type of nodes, etc.) on those connected nodes. Such a framework for decoupled knowledge graphs makes the knowledge graphs and their representational learning highly computationally efficient and adaptive to changes in the network.

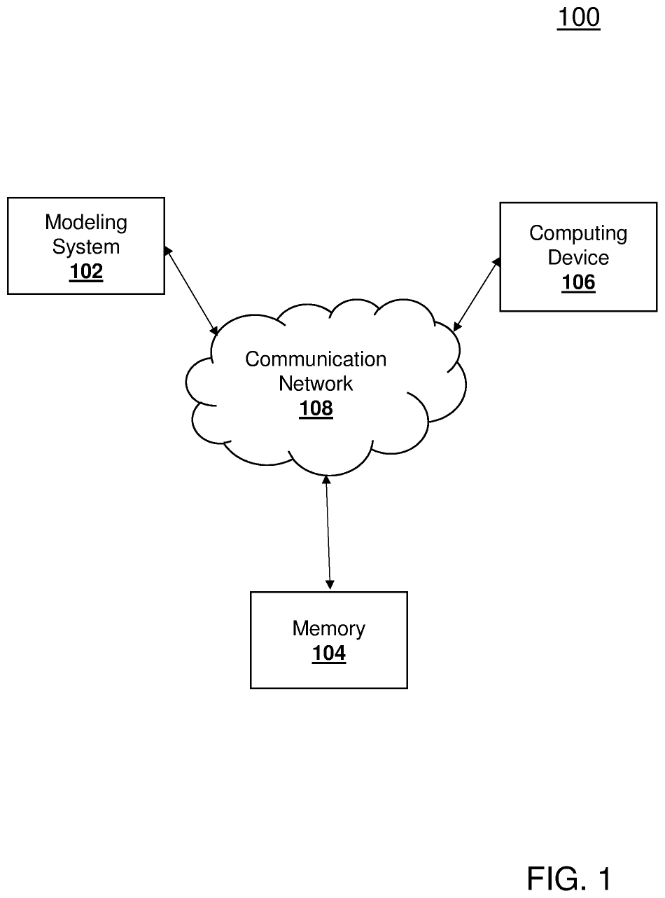

Referring now to FIG. 1, FIG. 1 is a diagram of an example environment 100 in which devices, systems, and/or methods, described herein, may be implemented. As shown in FIG. 1, environment 100 may include modeling system 102, memory 104, computing device 106, and communication network 108. Modeling system 102, memory 104, and computing device 106 may interconnect (e.g., establish a connection to communicate) via wired connections, wireless connections, or a combination of wired and wireless connections. In some non-limiting embodiments or aspects, environment 100 may further include a natural language processing system, an advertising system, a fraud detection system, a transaction processing system, a merchant system, an acquirer system, an issuer system, and/or a payment device.

Modeling system 102 may include one or more computing devices configured to communicate with memory 104 and/or computing device 106 at least partly over communication network 108. Modeling system 102 may be configured to receive data to train one or more machine learning models, train one or more machine learning models using the received data, and use one or more trained machine learning models to generate an output (e.g., a classification, and one or more actions triggered in response to the classification). Modeling system 102 may include or be in communication with memory 104. Modeling system 102 may be associated with, or included in a same system as, a natural language processing system, a fraud detection system, an advertising system, and/or a transaction processing system.

Memory 104 may include one or more computing devices configured to communicate with modeling system 102 and/or computing device 106 at least partly over communication network 108. Memory 104 may be configured to store data in one or more non-transitory computer readable storage media, wherein the stored data is used to train or test machine learning models, as well as well as to generate output using one or more machine learning models. Memory 104 may further store the one or more machine learning models. Memory 104 may communicate with and/or be included in modeling system 102.

Computing device 106 may include one or more processors that are configured to communicate with modeling system 102 and/or memory 104 at least partly over communication network 108. Computing device 106 may be associated with a user and may include at least one user interface for transmitting data to and receiving data from modeling system 102 and/or memory 104. For example, computing device 106 may show, on a display of computing device 106, one or more outputs of trained machine learning models executed by modeling system 102. By way of further example, one or more inputs for trained machine learning models may be determined or received by modeling system 102 via a user interface of computing device 106. Computing device 106 may have an input component for a user to enter and/or select data that may be used as an input for trained machine learning models. In some non-limiting embodiments or aspects, computing device 106 may be a mobile device.

Communication network 108 may include one or more wired and/or wireless networks over which the systems and devices of environment 100 may communicate. For example, communication network 108 may include a cellular network (e.g., a long-term evolution (LTE®) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of devices and networks shown in FIG. 1 are provided as an example. There may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally or alternatively, a set of devices (e.g., one or more devices) of environment 100 may perform one or more functions described as being performed by another set of devices of environment 100.

In some non-limiting embodiments or aspects, modeling system 102 may be programmed and/or configured to perform one or more steps of a method for machine learning using decoupled knowledge graphs. For example, modeling system 102 may be programmed or configured to generate a knowledge graph including a plurality of nodes (e.g., vertices) connected by a plurality of edges (e.g., connections), based on transaction data of a plurality of entities in a network. The transaction data may include data of a plurality of transactions between a plurality of payment devices and a plurality of merchants. Transaction data may include, but is not limited to, transaction amount, transaction date, transaction time, transaction description, payment device identifier, merchant identifier, merchant category code (MCC), transaction type, and/or the like. Entities may include, but are not limited to, merchants, payment device holders, payment devices, issuers, acquirers, payment gateways, and/or the like, and may further include identifiable categories to which transactions may be attributed, such as city, zip code, merchant category, and/or the like. The network may include, but is not limited to, an electronic payment processing network. An entity may be added to the network prior to the entity beginning to interact (e.g., transact) in the network (e.g., a new merchant is ready to transact with customers). An entity may be removed from the network when the entity no longer will interact (e.g., transact) in the network (e.g., a merchant is no longer in business).

In some non-limiting embodiments or aspects, modeling system 102 may generate the knowledge graph by generating a plurality of nodes, which includes entity nodes (e.g., nodes associated with entities) and non-entity nodes (e.g., nodes associated with attributes of entities or entity activity in the network). For example, modeling system 102 may generate a plurality of entity nodes, where each entity node of the plurality of entity nodes is associated with an entity of the plurality of entities. By way of further example, the set of non-entity nodes may be the set of the plurality of nodes exclusive of the set of entity nodes (e.g., where the entity nodes are merchant nodes, the non-entity nodes may include all other nodes besides the merchant entity nodes, which may be nodes associated with other types of entities besides merchants, transaction attributes, and/or the like). To illustrate, an entity node may be a node representative of a merchant in the network. Modeling system 102 may then determine a distribution of values for at least one attribute (e.g., parameter, feature, etc.) of the plurality of entities in the network, based on the transaction data. For example, the attribute may be an average daily transaction amount for a merchant entity. A value of average daily transaction amount may be an average amount (e.g., mean) of currency (e.g., United States dollar (USD)) received in transactions completed with the merchant in a day. Therefore, modeling system 102 may determine a distribution (e.g., a range of values, their rate of occurrence, etc.) of average daily transaction amounts across all merchant entities in the network. In this manner, modeling system 102 may determine one or more distributions of values for a number of attributes of entities in the network.

Modeling system 102 may further generate the knowledge graph by generating at least one lower attribute node of the plurality of nodes associated with a lower subset of values for the at least one attribute, based on the distribution of values. For example, in determining the distribution of values of average daily transaction amount, modeling system 102 may determine that a lower subset (e.g., a lower percentile) of those values are average daily transaction amounts in the range of $0-$1,000 (e.g., lower bound inclusive, upper bound non-inclusive). The lower subset of values may be determined based on a predetermined proportion (e.g., a lower tenth, a lower quartile, a lower third, a lower half, etc.) of the distribution of values. Therefore, a lower attribute node may be a non-entity node associated with a lower subset of values for a given attribute.

Modeling system 102 may further generate the knowledge graph by generating at least one higher attribute node of the plurality of nodes associated with a higher subset of values for the at least one attribute, based on the distribution of values. For example, in determining the distribution of values of average daily transaction amount, modeling system 102 may determine that a higher subset (e.g., a higher percentile) of those values are average daily transaction amounts in the range of $10,000-$100,000 (e.g., lower bound inclusive). The higher subset of values may be determined based on a predetermined proportion (e.g., an upper tenth, an upper quartile, an upper third, an upper half, etc.) of the distribution of values. Therefore, a higher attribute node may be a non-entity node associated with a higher subset of values for a given attribute. It will be appreciated that, in some non-limiting embodiments or aspects, a lower attribute node and a higher attribute node, as a pair, may be associated with the full distribution of values of an attribute. In some non-limiting embodiments or aspects, a lower attribute node and a higher attribute node, taken together, may be associated with only part of the full distribution of values of an attribute. Additionally or alternatively, additional attribute nodes (e.g., a middle attribute node) may be used in combination to represent the full distribution of values for an attribute. The range of values associated with a lower attribute node may be non-overlapping with the range of values associated with a higher attribute node.

Modeling system 102 may further generate the knowledge graph by generating at least one middle attribute node of the plurality of nodes associated with a middle subset of values for the at least one attribute, based on the distribution of values. For example, in determining the distribution of values of average daily transaction amount, modeling system 102 may determine that a middle subset (e.g., a middle percentile) of those values are average daily transaction amounts in the range of $1,000-$10,000 (e.g., lower bound inclusive, upper bound non-inclusive). The middle subset of values may be determined based on a predetermined proportion (e.g., a middle tenth, a middle quartile, a middle third, etc.) of the distribution of values. Therefore, a middle attribute node may be a non-entity node associated with a middle subset of values for a given attribute. It will be appreciated that, in some non-limiting embodiments or aspects, a lower attribute node, a middle attribute node, and a higher attribute node, in combination, may be associated with the full distribution of values of an attribute. In some non-limiting embodiments or aspects, a lower attribute node, a middle attribute node, and a higher attribute node, taken together, may be associated with only part of the full distribution of values of an attribute. Additionally or alternatively, additional attribute nodes (e.g., a lower-mid attribute node, an upper-mid attribute node, etc.) may be used in combination to represent the full distribution of values for an attribute. The range of values associated with each attribute node may be non-overlapping with other attribute nodes associated with the same attribute.

When determining the subsets of values for lower attribute nodes, middle attribute nodes, and/or higher attribute nodes, modeling system 102 may determine a histogram associated with the attribute using historic data of entities exhibiting that attribute. Modeling system 102 may then separate a distribution of values of the attribute into two or more zones (e.g., low and high, low and middle and high, etc.). Each zone of values may correspond to an attribute node (e.g., a lower attribute node, a middle attribute node, a higher attribute node). When determining edges that connect entity nodes to non-entity nodes (e.g., attribute nodes), modeling system 102 may map each merchant's attribute into one of the zones of values. For example, for a merchant node, modeling system 102 may determine an average daily transaction amount and determine which zone of values the merchant's average daily transaction amount is associated with (e.g., a lower subset of values, a middle subset of values, a higher subset of values, etc.). An edge may connect the merchant node to its respective attribute node based on the relationship between the merchant's exhibited attribute value and a zone of values associated with an attribute node.

In some non-limiting embodiments or aspects, and with further reference to the foregoing, modeling system 102 may generate the knowledge graph by generating a plurality of edges. Each edge of the plurality of edges may be associated with a relationship between the two nodes. For example, an edge connecting an entity node to a non-entity node may represent that the entity node exhibits the qualities of the non-entity node. By way of further example, a merchant entity node may be connected by edge to a lower attribute node associated with a lower subset of values for average daily transaction amount. Modeling system 102 may generate this connection between the merchant entity node and the lower attribute node based on the transaction data (e.g., the merchant may have an average daily transaction amount associated with the lower subset of values that is represented by the lower attribute node). In this manner, an entity node may be connected to one or more non-entity nodes, which indicates one or more associations between the entity node and connected non-entity nodes. Moreover, a non-entity node (e.g., an attribute node) may be connected to one or more entity nodes, which indicates one or more associations between the non-entity node and connected entity nodes. Modeling system 102 may generate attribute nodes for each attribute of a plurality of attributes, a plurality of entity nodes, and a plurality of edges connecting attribute nodes with the plurality of entity nodes, thereby forming the knowledge graph based on the transaction data of the entities in the network. The knowledge graph may be based on transaction data received (e.g., processed by a transaction processing system, retrieved from memory 104, etc.) in connection with a first time period (e.g., transactions occurring in a given day, week, month, quarter, year, etc.).

After generating the knowledge graph, modeling system 102 may group the nodes of the knowledge graph into an entity nodes group and a non-entity nodes group. This separation of node types, and the steps that follow, provides a basis for referring to knowledge graph as being “decoupled”, since the attributes and merchants are decoupled into entity and non-entity nodes. For example, for merchant entities, modeling system 102 may group the nodes into a merchant group N_{mrch} and a non-merchant group N_{non-mrch}. This notation may be abstracted to an entity group and a non-entity group, such as N_{entity} and N_{non-entity}. The generated knowledge graph may be represented as:

{(u,e,v),u∈N_{entity},v∈N_{non-entity},e∈Rₐₜₜᵣ} Formula 1

where u represents a node in the set of entity nodes N_{entity}, V represents a node in the set of non-entity nodes N_{non-entity}, and e represents an edge in the set of edges Rₐₜₜᵣ. The set of edges is represented in Formula 1 as Rₐₜₜᵣ, since it may be referred to as a set of attribute relationships.

After generating the knowledge graph, modeling system 102 may initialize embeddings associated with the plurality of nodes in each group. For example, modeling system 102 may generate embeddings for each node of the plurality of nodes using random values (e.g., random initialization). The random values may be generated based on the transaction data received by modeling system 102.

After initializing the embeddings associated with the plurality of nodes, modeling system 102 may generate learned representations of the plurality of nodes by repeatedly updating the embeddings associated with the plurality of nodes until convergence on the learned representations. The embeddings of the set of non-entity nodes may be updated while holding the embeddings of the set of entity nodes static, and vice versa, as further described below. While the embeddings have not yet converged, modeling system 102 may loop through layers of updates using a graph neural network (GNN). For each layer k in the set of layers K (e.g., depth of aggregation) of the GNN (e.g., “For k in [1:K], do.”), modeling system 102 may first loop through updating each entity node u in the set of entity nodes N_{entity} (e.g., “For u∈N_{entity}, do:”). Updating each entity node may be represented as:

$${h}_{u}^{( k + 1 )} = {update}_{entity}^{( k )} ( {h}_{u}^{( k )} , {aggregate}_{entity}^{( k )} ( \{ {h}_{v}^{( k )} , ∀ v ∈ {𝒩}_{n o n - e n t i t y} ( u ) \} ) ) \qquad Formula 2$$

where h is the vector representation of a node (e.g., an embedding), V represents the universal quantifier from predicate logic associated with “for all”, update( ) represents an update function accepting two inputs, aggregate( ) represents an aggregate function accepting two inputs, and [symbol] (i) represents the k-step neighborhood nodes of node i (e.g., when k=1, the k-step neighborhood is the set of nodes directly connected to node i). In this manner, modeling system 102 may update the embeddings of the entity nodes while holding the embeddings of the non-entity nodes static.

After looping through each entity node, and within each loop of each layer k in the set of layers K, modeling system 102 may loop through updating each non-entity node v in the set of non-entity nodes N_{non-entity} (e.g., “For v∈N_{non-entity}, do.”). Updating each non-entity node may be represented as:

$${h}_{v}^{( k + 1 )} = {update}_{non - entity}^{( k )} ( {h}_{v}^{( k )} , {aggregate}_{non - entity}^{( k )} ( \{ {h}_{v}^{( k )} , ∀ u ∈ {𝒩}_{entity} ( v ) \} ) ) \qquad Formula 3$$

using the same notation as in Formula 2. In this manner, modeling system 102 may update the embeddings of the non-entity nodes while holding the embeddings of the entity nodes static.

It will be appreciated that the update function may be used with respect to one or more aggregation techniques (e.g., aggregation processes, protocols, functions, etc.), as represented in Formula 2 and Formula 3. The aggregation technique may be used to identify an aggregate value (e.g., a maximum value, a mean value, etc.) of nodes in a k-step neighborhood (e.g., 1 step) associated with the node for which an embedding is being updated. For example, the aggregation technique may be a pool aggregation technique. In such an example, the update function may include a pool aggregator, which may be represented as:

$${h}_{u}^{( k + 1 )} = σ ( {W}_{1}^{( k )} . ( {h}_{u}^{( k )} \vert max ( \{ σ ( {W}_{2}^{( k )} \cdot {h}_{i}^{( k )} + b ) , ∀ i ∈ {𝒩}_{u} \} ) ) ) \qquad Formula 4$$

$${h}_{v}^{( k + 1 )} = σ ( {W}_{3}^{( k )} \cdot ( {h}_{v}^{( k )} \vert max ( \{ σ ( {W}_{4}^{( k )} \cdot {h}_{i}^{( k )} + b ) , ∀ i ∈ {𝒩}_{v} \} ) ) ) \qquad Formula 5$$

where σ is the sigmoid function and W and b are learnable parameters in the neural network. Formula 4 represents an update function with a pool aggregator for entity node embeddings, and Formula 5 represents an update function with a pool aggregator for non-entity node embeddings. The pool aggregation technique, as shown above, may be used to identify a maximum value of nodes in a k-step neighborhood associated with a node for which the embedding is being updated.

By way of another example, the aggregation technique may be a mean aggregation technique. In such an example, the update function may include a mean aggregator, which may be represented as:

$${h}_{u}^{( k + 1 )} = σ ( {W}_{1}^{( k )} \cdot ( {h}_{u}^{( k )} \vert σ ( {W}_{2}^{( k )} \cdot {\sum }_{i ∈ {𝒩}_{u}} \frac{1}{{c}_{u}} {h}_{i}^{( k )} ) ) ) \qquad Formula 6$$

$${h}_{v}^{( k + 1 )} = σ ( {W}_{3}^{( k )} \cdot ( {h}_{v}^{( k )} \vert σ ( {W}_{4}^{( k )} \cdot {\sum }_{i ∈ {𝒩}_{v}} \frac{1}{{c}_{v}} {h}_{i}^{( k )} ) ) ) \qquad Formula 7$$

where c is a learnable parameter in the neural network (other notation representing the same as in Formula 4 and Formula 5). Formula 6 represents an update function with a mean aggregator for entity node embeddings, and Formula 7 represents an update function with a mean aggregator for non-entity node embeddings. The mean aggregation technique, as shown above, may be used to identify a mean value of nodes in a k-step neighborhood associated with a node for which the embedding is being updated.

In some non-limiting embodiments or aspects, and in view of the above, modeling system 102 may generate the learned representations by repeatedly updating the embeddings until convergence of the embeddings on the learned representations. To do so, modeling system 102 may update the embeddings of the plurality of entity nodes while holding the embeddings of the plurality of non-entity nodes (e.g., attribute nodes) static. Likewise, modeling system 102 may update the embeddings of the plurality of non-entity nodes while holding the embeddings of the plurality of entity nodes static. After generating the learned representations, modeling system 102 may execute at least one classification machine learning model (e.g., a fraud detection model, a targeted advertisement model, a network security threat detection model, etc.) using the learned representations of the plurality of nodes. The output of the classification machine learning model (e.g., a classification) may then be used to trigger one or more actions in response (e.g., fraud mitigation actions to react to the detection of fraud based on the output of a fraud detection model).

In the machine learning process, the following may be learned for a previously built entity knowledge graph:

$$\{ {ε}_{l} , ∀ l ∈ \{ {N}_{entity} \vert {N}_{non - entity} \} \} \qquad Formula 8$$

$${aggregate}_{enti t y}^{( k )} ( . ) , k ∈ [ 1 : K ] \qquad Formula 9$$

$${update}_{e n t i t y}^{( k )} ( . ) , k ∈ [ 1 : K ] \qquad Formula 10$$

$${aggregate}_{n o n - e n t i t y}^{( k )} ( . ) , k ∈ [ 1 : K ] \qquad Formula 11$$

$${update}_{n o n - e n t i t y}^{( k )} ( . ) , k ∈ [ 1 : K ] \qquad Formula 12$$

Moreover, the learned representations of the embeddings ({εₗ, ∀I∈{N_{entity}}}) may be used directly in downstream tasks, such as classification tasks using machine learning models (e.g., fraud detection, targeted advertisement selection, network anomaly detection, etc.).

In some non-limiting embodiments or aspects, modeling system 102 may execute a series of steps in response to a new entity being added to the network (e.g., new merchant joining electronic payment processing network, new payment device being added to fraud detection network, new computer being added to secured network, etc.). The series of steps may include generating a new entity node of the plurality of nodes of the knowledge graph, wherein the new entity node is associated with the new entity. Modeling system 102 may then generate at least one new edge of the plurality of the edges of the knowledge graph, wherein the at least one new edge connects the new entity node to at least one other node (e.g., a non-entity node, such as an attribute node) of the plurality of nodes (e.g., based on transaction data associated with the new entity). Modeling system 102 may then generate a default embedding (e.g., based on an average embedding for the entity type, with random initializations, etc.) for the new entity node, and then proceed to update the default embedding of the new entity node to an updated embedding while holding the embeddings of the plurality of non-entity nodes static. Updating the embedding of the new entity node may include updating the embedding of the new entity node using the aggregation technique (e.g., pool aggregation, mean aggregation etc.) to identify a value of entity nodes in a k-step (e.g., 1-step) neighborhood associated with the new entity node. Modeling system 102 may then re-execute (e.g., execute again in a subsequent time interval after the first execution) the at least one classification machine learning model based at least partially on the updated embedding of the new entity node.

With further reference to the foregoing, modeling system 102 may execute an update procedure when a new node is added to the knowledge graph associated with the network, including both new entity nodes and new non-entity nodes. If the new node added to the graphed network is associated with a new entity (e.g., a merchant), modeling system 102 may execute an update function to generate an updated embedding (h), having the notation:

$$h = {update}_{entity}^{( K )} ( {h}_{entity - default} , {aggregate}_{entity}^{( K )} ( \{ {h}_{v} , ∀ v ∈ 𝒩 ( u ) \} ) ) \qquad Formula 13$$

If the new node added to the graphed network is associated with a new attribute (e.g., a new feature), modeling system 102 may execute an update function to generate an updated embedding (h) having the notation:

$$h = {update}_{non - entity}^{( K )} ( {h}_{non - entity - default} , {aggregate}_{non - entity}^{( K )} ( \{ {h}_{u} , ∀ u ∈ 𝒩 ( v ) \} ) ) \qquad Formula 14$$

With further reference to the foregoing, modeling system 102 may execute an update procedure when a change to the network has occurred (e.g., drift in attribute value over time, removed attributes, removed entities, etc.). In such an instance, modeling system 102 may adjust the existing learned representations for an affected node, which may be a node that was connected to a removed node or a node whose values have changed over time. If an affected node is associated with an entity, modeling system 102 may execute an update function to generate an updated embedding (h^{updated}) having the notation:

$${h}_{u}^{updated} = {update}_{entity}^{( K )} ( {h}_{u}^{current} , {aggregate}_{entity}^{( K )} ( \{ {h}_{v}^{current} , ∀ v ∈ {{𝒩}^{′}}_{non - entity} ( u ) \} ) ) \qquad Formula 15$$

If the affected node is associated with a non-entity (e.g., an attribute), modeling system 102 may execute an update function to generate an updated embedding (h^{updated}) having the notation:

$${h}_{v}^{updated} = {update}_{non - entity}^{( K )} ( {h}_{v}^{current} , {aggregate}_{non - entity}^{( K )} ( \{ {h}_{v}^{current} , ∀ u ∈ {{𝒩}^{′}}_{entity} ( v ) \} ) ) \qquad Formula 16$$

In some non-limiting embodiments or aspects, modeling system 102 may execute a series of steps in response to an entity being removed from the network (e.g., a merchant no longer participating in the electronic payment processing network, a payment device being deactivated, a computer being removed from a secure network, etc.). The series of steps may include removing a first entity node from the knowledge graph associated with the entity removed from the network. Modeling system 102 may then identify a second entity node that was previously connected to the first entity node in the knowledge graph. Modeling system 102 may then update an embedding of the second entity node to an updated embedding while holding the embeddings of the plurality of non-entity nodes static. Updating the embedding of the second entity node may include updating the embedding of the second entity node using the aggregation technique (e.g., pool aggregation, mean aggregation, etc.), to identify a value of entity nodes in a k-step neighborhood (e.g., 1-step) associated with the second entity node. Modeling system 102 may then re-execute the at least one classification machine learning model based at least partially on the updated embedding of the second entity node.

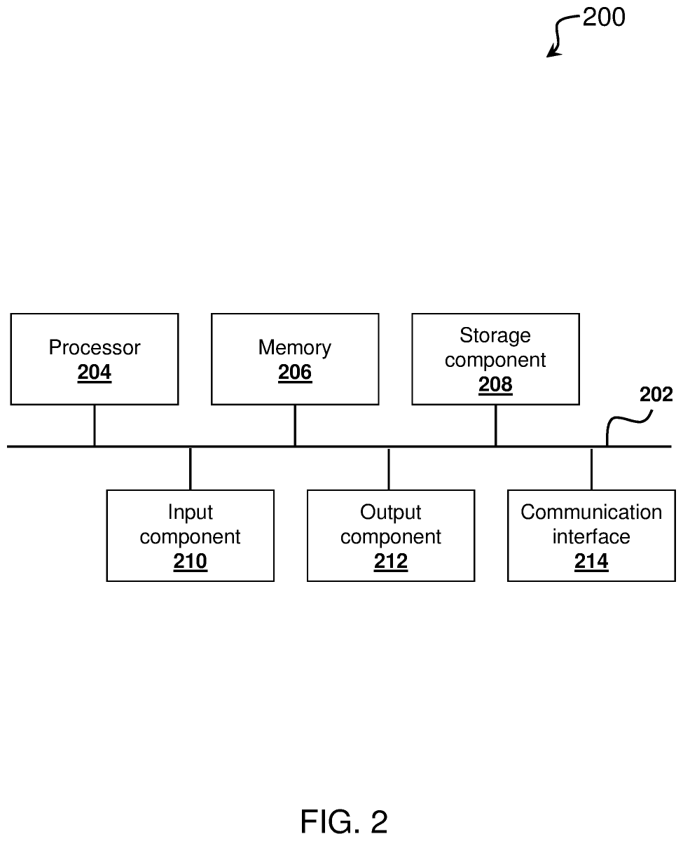

Referring now to FIG. 2, FIG. 2 is a diagram of example components of a device 200, according to some non-limiting embodiments or aspects. Device 200 may correspond to one or more devices of modeling system 102, memory 104, computing device 106, and/or communication network 108, as shown in FIG. 1. In some non-limiting embodiments or aspects, such systems or devices may include at least one device 200 and/or at least one component of device 200.

As shown in FIG. 2, device 200 may include bus 202, processor 204, memory 206, storage component 208, input component 210, output component 212, and communication interface 214. Bus 202 may include a component that permits communication among the components of device 200. In some non-limiting embodiments or aspects, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read only memory (ROM), and/or another type of dynamic or static storage device (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.) and/or another type of computer-readable medium.

Input component 210 may include a component that permits device 200 to receive information, such as via user input (e.g., a touch screen display, a keyboard, a keypad, a mouse, a button, a switch, a microphone, etc.). Additionally, or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally, or alternatively, hardwired circuitry may be used in place of or in combination with software instructions to perform one or more processes described herein.

The number and arrangement of components shown in FIG. 2 are provided as an example. In some non-limiting embodiments, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

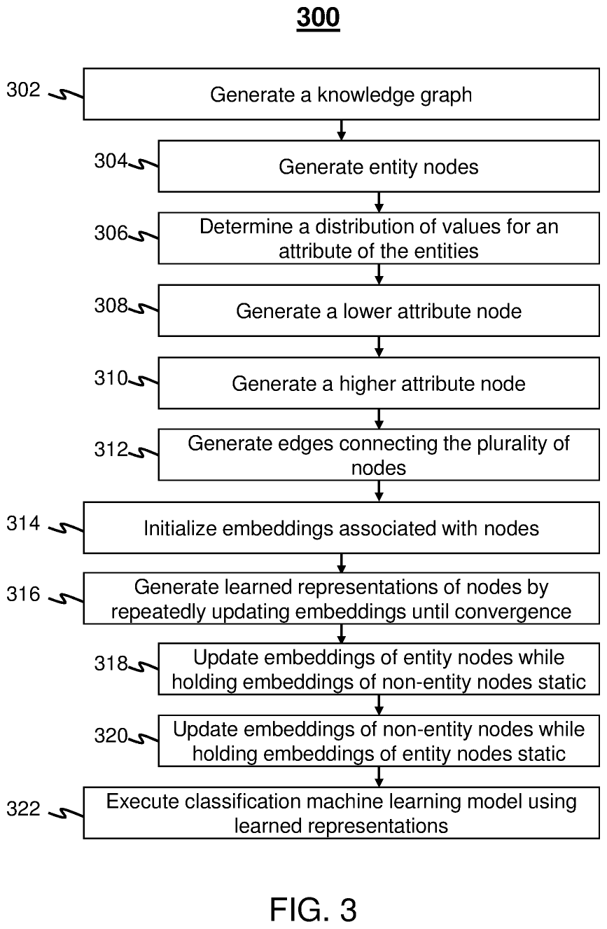

Referring now to FIG. 3, FIG. 3 is a flowchart of a non-limiting embodiment or aspect of a process 300 for machine learning using decoupled knowledge graphs, according to some non-limiting embodiments or aspects. The steps shown in FIG. 3 are for example purposes only. It will be appreciated that additional, fewer, different, and/or a different order of steps may be used in non-limiting embodiments or aspects. In some non-limiting embodiments or aspects, one or more of the steps of process 300 may be performed (e.g., completely, partially, and/or the like) by modeling system 102. In some non-limiting embodiments or aspects, one or more of the steps of process 300 may be performed (e.g., completely, partially, and/or the like) by another system, another device, another group of systems, or another group of devices, separate from or including modeling system 102.

As shown in FIG. 3, at step 302, process 300 may include generating a knowledge graph. For example, modeling system 102 may generate a knowledge graph including a plurality of nodes connected by a plurality of edges. Modeling system 102 may generate the knowledge graph based on transaction data of a plurality of entities in the network. Generating the knowledge graph at step 302 may include executing steps 304, 306, 308, 310, and 312.

As shown in FIG. 3, at step 304, generating the knowledge graph in process 300 may include generating entity nodes. For example, modeling system 102 may generate a plurality of entity nodes of the plurality of nodes, wherein each entity node of the plurality of entity nodes is associated with an entity of the plurality of entities.

As shown in FIG. 3, at step 306, generating the knowledge graph in process 300 may include determining a distribution of values for an attribute of the entities. For example, modeling system 102 may determine a distribution of values for at least one attribute of the plurality of entities in the network, based on the transaction data.

As shown in FIG. 3, at step 308, generating the knowledge graph in process 300 may include generating a lower attribute node. For example, modeling system 102 may generate at least one lower attribute node of the plurality of nodes associated with a lower subset of values for the at least one attribute, based on the distribution of values.

As shown in FIG. 3, at step 310, generating the knowledge graph in process 300 may include generating a higher attribute node. For example, modeling system 102 may generate at least one higher attribute node of the plurality of nodes associated with a higher subset of values for the at least one attribute, based on the distribution of values.

As shown in FIG. 3, at step 312, generating the knowledge graph in process 300 may include generating edges connecting the plurality of nodes. For example, modeling system 102 may generate the plurality of edges, wherein each edge of the plurality of edges connects two nodes of the plurality of nodes and is associated with a relationship between the two nodes.

As shown in FIG. 3, at step 314, process 300 may include initializing embeddings associated with nodes. For example, modeling system 102 may initialize embeddings associated with the plurality of nodes of the knowledge graph by initializing the embeddings with random values.

As shown in FIG. 3, at step 316, process 300 may include generating learned representations of nodes by repeatedly updating embeddings until convergence. For example, modeling system 102 may generate learned representations of the plurality of nodes by repeatedly updating the embeddings associated with the plurality of nodes until convergence of the embeddings on the learned representations. Updating the embeddings may include executing steps 318 and 320.

As shown in FIG. 3, at step 318, updating the embeddings of process 300 may include updating the embeddings of entity nodes while holding embeddings of non-entity nodes static. For example, modeling system 102 may update the embeddings of the plurality of entity nodes while holding the embeddings of a plurality of non-entity nodes of the plurality of nodes static. The plurality of non-entity nodes may include a set of the plurality of nodes exclusive of the plurality of entity nodes (e.g., the attribute nodes).

As shown in FIG. 3, at step 310, updating the embeddings of process 300 may include updating the embeddings of the non-entity nodes while holding the embeddings of the entity nodes static. For example, modeling system 102 may update the embeddings of the plurality of non-entity nodes while holding the embeddings of the plurality of entity nodes static.

As shown in FIG. 3, at step 322, process 300 may include executing a classification machine learning model using the learned representations. For example, modeling system 102 may execute at least one classification machine learning model using the learned representations of the plurality of nodes.

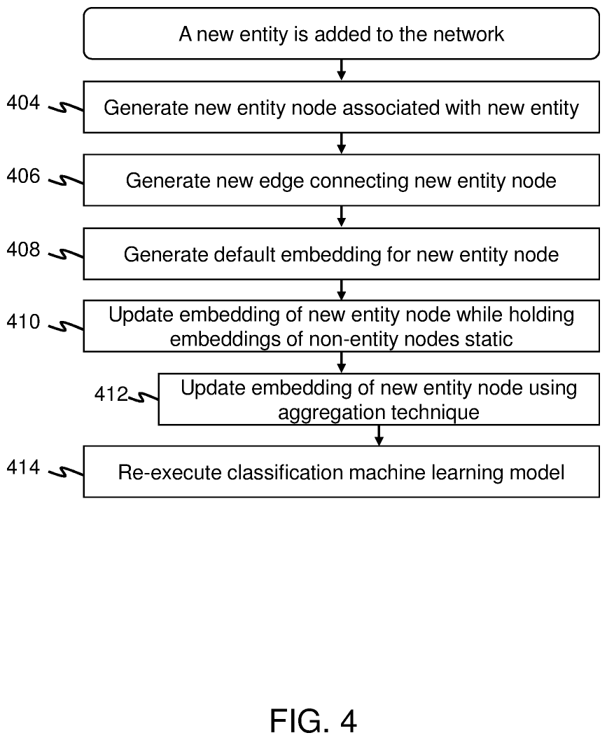

Referring now to FIG. 4, FIG. 4 is a flowchart of a non-limiting embodiment or aspect of a process 400 for machine learning using decoupled knowledge graphs, according to some non-limiting embodiments or aspects. In particular, process 400 depicts a series of steps associated with a new entity being added to the network, which may occur after learned representations of an initial network state are generated (see, e.g., FIG. 3). The steps shown in FIG. 4 are for example purposes only. It will be appreciated that additional, fewer, different, and/or a different order of steps may be used in non-limiting embodiments or aspects. In some non-limiting embodiments or aspects, one or more of the steps of process 400 may be performed (e.g., completely, partially, and/or the like) by modeling system 102. In some non-limiting embodiments or aspects, one or more of the steps of process 400 may be performed (e.g., completely, partially, and/or the like) by another system, another device, another group of systems, or another group of devices, separate from or including modeling system 102.

As shown in FIG. 4, steps 404, 406, 408, 410, 412, and 414 may be triggered in response to a new entity being added to the network. Modeling system 102 may detect the new entity being added to the network, may receive a message indicating that the new entity was added to the network, may add the new entity to the network, and/or the like. Modeling system 102 may, through one or more of the above conditions, determined that a new entity has been added to the network and may trigger step 404 in response to the determination.

As shown in FIG. 4, at step 404, process 400 may include generating a new entity node associated with the new entity. For example, modeling system 102 may generate a new entity node of the plurality of nodes of the knowledge graph associated with the new entity.

As shown in FIG. 4, at step 406, process 400 may include generating a new edge connecting the new entity node. For example, modeling system 102 may generate at least one new edge of the plurality of edges of the knowledge graph. The at least one new edge may connect the new entity node to at least one other node of the plurality of nodes (e.g., an attribute node). Modeling system 102 may generate the at least one new edge based on transaction data associated with the new entity.

As shown in FIG. 4, at step 408, process 400 may include generating a default embedding for the new entity node. For example, modeling system 102 may generate a default embedding for the new entity node that was added to the network.

As shown in FIG. 4, at step 410, process 400 may include updating embeddings of the new entity node while holding embeddings of non-entity nodes static. For example, modeling system 102 may update the embedding of the new entity node while holding the embeddings of the plurality of non-entity nodes static. Updating the embeddings of the new entity node may include step 412.

As shown in FIG. 4, at step 412, updating the embedding of the new entity node in process 400 may include updating the embedding of the new entity node using an aggregation technique. For example, modeling system 102 may update the embedding of the new entity node using the aggregation technique (e.g., pool aggregation, mean aggregation, etc.) to identify a value of entity nodes in a k-step neighborhood associated with the new entity node.

As shown in FIG. 4, at step 414, process 400 may include re-executing the classification machine learning model. For example, modeling system 102 may re-execute the at least one classification machine learning model based at least partially on the updated embedding of the new entity node.

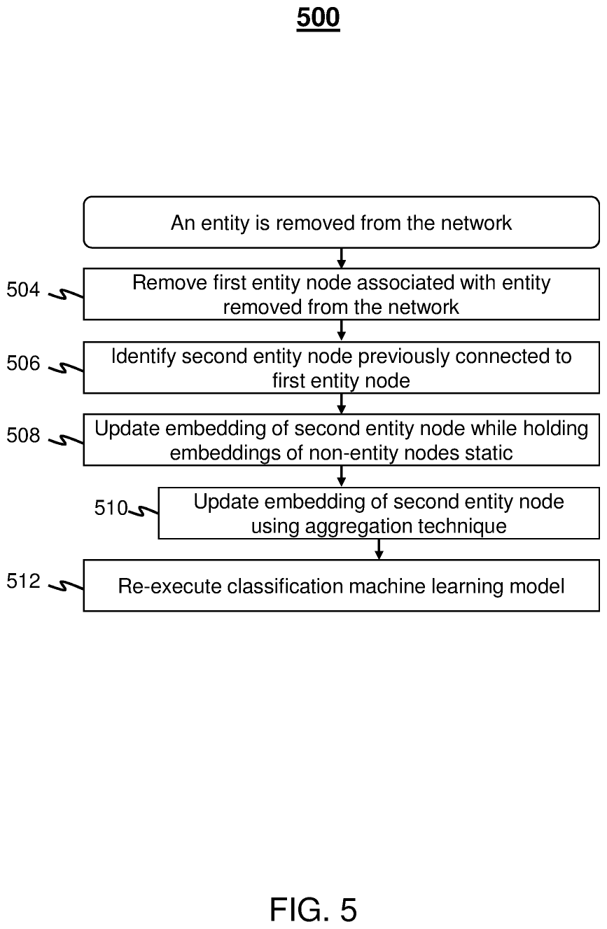

Referring now to FIG. 5, FIG. 5 is a flowchart of a non-limiting embodiment or aspect of a process 500 for machine learning using decoupled knowledge graphs, according to some non-limiting embodiments or aspects. In particular, process 500 depicts a series of steps associated with an entity being removed from the network, which may occur after learned representations of an initial network state are generated (see, e.g., FIG. 3). The steps shown in FIG. 5 are for example purposes only. It will be appreciated that additional, fewer, different, and/or a different order of steps may be used in non-limiting embodiments or aspects. In some non-limiting embodiments or aspects, one or more of the steps of process 500 may be performed (e.g., completely, partially, and/or the like) by modeling system 102. In some non-limiting embodiments or aspects, one or more of the steps of process 500 may be performed (e.g., completely, partially, and/or the like) by another system, another device, another group of systems, or another group of devices, separate from or including modeling system 102.

As shown in FIG. 5, steps 504, 506, 508, 510, and 512 may be triggered in response to an entity being removed from the network. Modeling system 102 may detect the entity being removed from the network, may receive a message indicating that the entity was removed from the network, may remove the entity from the network, and/or the like. Modeling system 102 may, through one or more of the above conditions, determine that an entity has been removed from the network and may trigger step 504 in response to the determination.

As shown in FIG. 5, at step 504, process 500 may include removing a first entity node that is associated with the entity removed from the network. For example, modeling system 102 may remove a first entity node from the knowledge graph that is associated with the entity removed from the network.

As shown in FIG. 5, at step 506, process 500 may include identifying a second entity node that was previously connected to the first entity node. For example, modeling system 102 may identify a second entity node of the knowledge graph that was previously connected to the first entity node in the knowledge graph. This identification may occur before, during, or after modeling system 102 removes first entity node from the knowledge graph (see step 504).

As shown in FIG. 5, at step 508, process 500 may include updating an embedding of the second entity node while holding embeddings of non-entity nodes static. For example, modeling system 102 may update an embedding of the second entity node to be an updated embedding, while holding the embeddings of the plurality of non-entity nodes (e.g., attribute nodes) static. Updating the embedding of the second entity node may include step 510.

As shown in FIG. 5, at step 510, updating the embedding of the second entity node in process 500 may include updating the embedding of the second entity node using an aggregation technique. For example, modeling system 102 may update the embedding of the second entity node using the aggregation technique (e.g., pool aggregation, mean aggregation, etc.) to identify a value of entity nodes in a k-step neighborhood associated with the second entity node.

As shown in FIG. 5, at step 512, process 500 may include re-executing the classification machine learning model. For example, modeling system 102 may re-execute the at least one classification machine learning model based at least partially on the updated embedding of the second entity node.

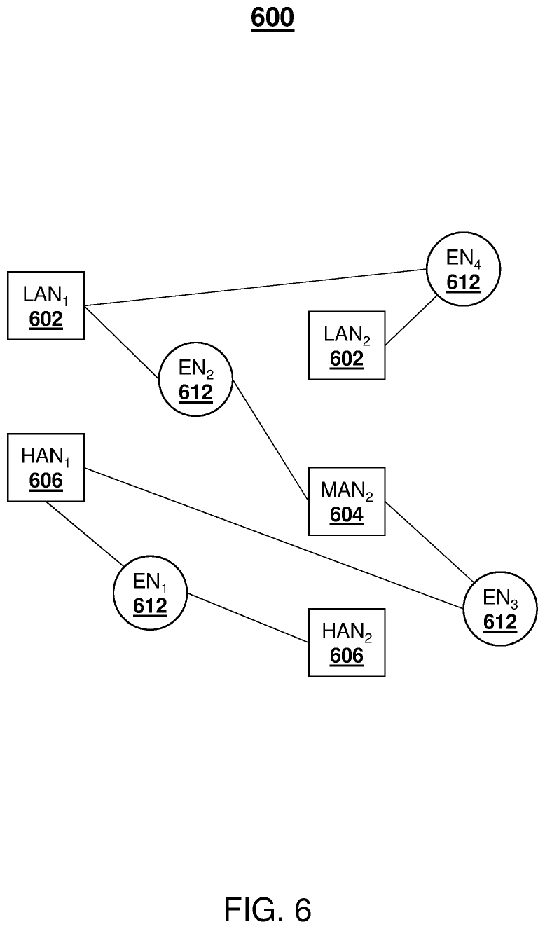

Referring now to FIG. 6, FIG. 6 is a schematic diagram of a non-limiting embodiment or aspect of an exemplary decoupled knowledge graph 600 for machine learning, according to some non-limiting embodiments or aspects. In particular exemplary decoupled knowledge graph 600 includes four entity nodes 612 (abbreviated EN₁, EN₂, EN₃, and EN₄) and five-non entity nodes (e.g., attribute nodes 602, 604, 606). The five-non entity nodes include a lower attribute node 602 associated with a first attribute (LAN₁), a higher attribute node 606 associated with the first attribute (HAN₁), a lower attribute node 602 associated with a second attribute (LAN₂), a middle attribute node 604 associated with the second attribute (MAN₂), and a higher attribute node 606 associated with the second attribute (HAN₂). The decoupled knowledge graph 600 shown in FIG. 6 is for illustrative purposes only and is not to be interpreted as limiting on the disclosure.

As depicted in FIG. 6, the first entity node 612 (EN₁) is associated with a first entity in the network (e.g., a merchant). EN₁ is connected by edge to a higher attribute node 606 associated with a first attribute (HAN₁) and is connected by edge to a higher attribute node 606 associated with a second attribute (HAN₂). The one-step neighborhood of nodes for EN₁ include HAN₁ and HAN₂. For example, modeling system 102 may determine, based on transaction data associated with the first entity, that the first entity exhibits attribute values associated with a higher subset of values of the first attribute and attribute values associated with a higher subset of values of the second attribute. By way of further example, if EN₁ is a merchant entity, modeling system 102 may determine that the first merchant is associated with a high average daily transaction amount (e.g., HAN₁) and a high total daily transaction amount (e.g., HAN₂).

As depicted in FIG. 6, the second entity node 612 (EN₂) is associated with a second entity in the network (e.g., a merchant). EN₂ is connected by edge to a lower attribute node 602 associated with a first attribute (LAN₁) and is connected by edge to a middle attribute node 604 associated with a second attribute (MAN₂). The one-step neighborhood of nodes for EN₂ include LAN₁ and MAN₂. For example, modeling system 102 may determine, based on transaction data associated with the second entity, that the second entity exhibits attribute values associated with a lower subset of values of the first attribute and attribute values associated with a middle subset of values of the second attribute. By way of further example, if EN₂ is a merchant entity, modeling system 102 may determine that the second merchant is associated with a low average daily transaction amount (e.g., LAN₁) and a moderate total daily transaction amount (e.g., MAN₂).

As depicted in FIG. 6, the third entity node 612 (EN₃) is associated with a third entity in the network (e.g., a merchant). EN₃ is connected by edge to a higher attribute node 606 associated with a first attribute (HAN₁) and is connected by edge to a middle attribute node 604 associated with a second attribute (MAN₂). The one-step neighborhood of nodes for EN₃ include HAN₁ and MAN₂. For example, modeling system 102 may determine, based on transaction data associated with the third entity, that the third entity exhibits attribute values associated with a high subset of values of the first attribute and attribute values associated with a middle subset of values of the second attribute. By way of further example, if EN₃ is a merchant entity, modeling system 102 may determine that the third merchant is associated with a high average daily transaction amount (e.g., HAN₁) and a moderate total daily transaction amount (e.g., MAN₂).

As depicted in FIG. 6, the fourth entity node 612 (EN₄) is associated with a fourth entity in the network (e.g., a merchant). EN₄ is connected by edge to a lower attribute node 602 associated with a first attribute (LAN₁) and is connected by edge to a lower attribute node 602 associated with a second attribute (LAN₂). The one-step neighborhood of nodes for EN₄ include LAN₁ and LAN₂. For example, modeling system 102 may determine, based on transaction data associated with the fourth entity, that the fourth entity exhibits attribute values associated with a low subset of values of the first attribute and attribute values associated with a low subset of values of the second attribute. By way of further example, if EN₄ is a merchant entity, modeling system 102 may determine that the fourth merchant is associated with a low average daily transaction amount (e.g., LAN₁) and a low total daily transaction amount (e.g., LAN₂).

Modeling system 102 may group the nodes into two sets of nodes. For example, modeling system 102 may group the entity nodes 612 into a set of entity nodes and may group the non-entity nodes 602, 604, 606 into a set of non-entity nodes. When generating learned representations of the embeddings of the entity nodes 612 in the knowledge graph 600, modeling system 102 may hold non-entity node 602, 604, 606 embeddings static while updating the entity node 612 embeddings until convergence is reached. Likewise, when generating learned representations of the embeddings of non-entity nodes 602, 604, 606 in knowledge graph 600, modeling system 102 may hold entity node 612 embeddings static while updating the non-entity node 602, 604, 606 embeddings until convergence is reached. Such decoupling lowers the computational resource load of a global update by dividing the computational labor into local updates based on type of node.

It will be appreciated that the entity nodes (EN₁, EN₂, EN₃, EN₄) in the knowledge graph may be associated with a same or different type of entity (e.g., merchant, payment device, computing device, etc.). When updating embeddings of entity nodes, modeling system 102 may update embeddings of all entity nodes of a same type while holding embeddings of all other nodes static (e.g., including entity nodes of a different type and non-entity nodes). Additionally or alternatively, when updating embeddings of entity nodes modeling system 102 may update embeddings of all entity nodes of some or all types while holding embeddings of all other nodes static.

Although the disclosure has been described in detail for the purpose of illustration based on what is currently considered to be the most practical and preferred embodiments or aspects, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect, and one or more steps may be taken in a different order than presented in the present disclosure.

What is claimed is:

1. A method comprising:
generating, with at least one processor, a knowledge graph comprising a plurality of nodes connected by a plurality of edges, based on transaction data of a plurality of entities in a network, wherein generating the knowledge graph comprises:
generating a plurality of entity nodes of the plurality of nodes, each entity node of the plurality of entity nodes associated with an entity of the plurality of entities;
determining a distribution of values for at least one attribute of the plurality of entities in the network, based on the transaction data;
generating at least one lower attribute node of the plurality of nodes associated with a lower subset of values for the at least one attribute, based on the distribution of values;
generating at least one higher attribute node of the plurality of nodes associated with a higher subset of values for the at least one attribute, based on the distribution of values; and
generating the plurality of edges, each edge of the plurality of edges connecting two nodes of the plurality of nodes and being associated with a relationship between the two nodes;
initializing, with at least one processor, embeddings associated with the plurality of nodes with random values;
generating, with at least one processor, learned representations of the plurality of nodes by repeatedly updating the embeddings associated with the plurality of nodes, wherein repeatedly updating the embeddings comprises, until convergence of the embeddings on the learned representations:
updating the embeddings of the plurality of entity nodes while holding the embeddings of a plurality of non-entity nodes of the plurality of nodes static, the plurality of non-entity nodes comprising a set of the plurality of nodes exclusive of the plurality of entity nodes; and
updating the embeddings of the plurality of non-entity nodes while holding the embeddings of the plurality of entity nodes static; and
executing, with at least one processor, at least one classification machine learning model using the learned representations of the plurality of nodes.

2. The method of claim 1, wherein updating the embeddings of the plurality of entity nodes comprises:
updating an embedding of each entity node of the plurality of entity nodes using an aggregation technique to identify a value of entity nodes in a k-step neighborhood associated with the entity node; and
wherein updating the embeddings of the plurality of non-entity nodes comprises:
updating an embedding of each non-entity node of the plurality of non-entity nodes using the aggregation technique to identify a value of non-entity nodes in a k-step neighborhood associated with the non-entity node.

3. The method of claim 2, wherein the aggregation technique is a pool aggregation technique, and wherein the pool aggregation technique identifies a maximum value of nodes in a k-step neighborhood associated with a node.

4. The method of claim 2, wherein the aggregation technique is a mean aggregation technique, and wherein the mean aggregation technique identifies a mean value of nodes in a k-step neighborhood associated with a node.

5. The method of claim 2, further comprising, in response to a new entity being added to the network:
generating, with at least one processor, a new entity node of the plurality of nodes of the knowledge graph associated with the new entity;
generating, with at least one processor, at least one new edge of the plurality of edges of the knowledge graph, wherein the at least one new edge connects the new entity node to at least one other node of the plurality of nodes;
generating, with at least one processor, a default embedding for the new entity node;
updating, with at least one processor, the embedding of the new entity node while holding the embeddings of the plurality of non-entity nodes static, wherein updating the embedding of the new entity node comprises:
updating the embedding of the new entity node using the aggregation technique to identify a value of entity nodes in a k-step neighborhood associated with the new entity node; and
re-executing, with at least one processor, the at least one classification machine learning model based at least partially on the updated embedding of the new entity node.

6. The method of claim 2, further comprising, in response to an entity being removed from the network:
removing, with at least one processor, a first entity node from the knowledge graph associated with the entity removed from the network;
identifying, with at least one processor, a second entity node previously connected to the first entity node in the knowledge graph;
updating, with at least one processor, an embedding of the second entity node while holding the embeddings of the plurality of non-entity nodes static, wherein updating the embedding of the second entity node comprises:
updating the embedding of the second entity node using the aggregation technique to identify a value of entity nodes in a k-step neighborhood associated with the second entity node; and
re-executing, with at least one processor, the at least one classification machine learning model based at least partially on the updated embedding of the second entity node.

7. The method of claim 1, wherein generating the knowledge graph further comprises:
generating at least one middle attribute node of the plurality of nodes associated with a middle subset of values for the at least one attribute, based on the distribution of values; and
wherein each entity node of the plurality of entity nodes is connected, for each attribute of the at least one attribute, to a lower attribute node, a middle attribute node, or a higher attribute node for the attribute, based on the transaction data.

8. A system comprising at least one processor programmed or configured to:
generate a knowledge graph comprising a plurality of nodes connected by a plurality of edges, based on transaction data of a plurality of entities in a network, wherein, when generating the knowledge graph, the at least one processor is programmed or configured to:
generate a plurality of entity nodes of the plurality of nodes, each entity node of the plurality of entity nodes associated with an entity of the plurality of entities;
determine a distribution of values for at least one attribute of the plurality of entities in the network, based on the transaction data;
generate at least one lower attribute node of the plurality of nodes associated with a lower subset of values for the at least one attribute, based on the distribution of values;
generate at least one higher attribute node of the plurality of nodes associated with a higher subset of values for the at least one attribute, based on the distribution of values; and
generate the plurality of edges, each edge of the plurality of edges connecting two nodes of the plurality of nodes and being associated with a relationship between the two nodes;
initialize embeddings associated with the plurality of nodes with random values;
generate learned representations of the plurality of nodes by repeatedly updating the embeddings associated with the plurality of nodes, wherein, when repeatedly updating the embeddings, the at least one processor is programmed or configured to, until convergence of the embeddings on the learned representations:
update the embeddings of the plurality of entity nodes while holding the embeddings of a plurality of non-entity nodes of the plurality of nodes static, the plurality of non-entity nodes comprising a set of the plurality of nodes exclusive of the plurality of entity nodes; and
update the embeddings of the plurality of non-entity nodes while holding the embeddings of the plurality of entity nodes static; and
execute at least one classification machine learning model using the learned representations of the plurality of nodes.

9. The system of claim 8, wherein, when updating the embeddings of the plurality of entity nodes, the at least one processor is programmed or configured to:
update an embedding of each entity node of the plurality of entity nodes using an aggregation technique to identify a value of entity nodes in a k-step neighborhood associated with the entity node; and
wherein, when updating the embeddings of the plurality of non-entity nodes, the at least one processor is programmed or configured to:
update an embedding of each non-entity node of the plurality of non-entity nodes using the aggregation technique to identify a value of non-entity nodes in a k-step neighborhood associated with the non-entity node.

10. The system of claim 9, wherein the aggregation technique is a pool aggregation technique, and wherein the pool aggregation technique identifies a maximum value of nodes in a k-step neighborhood associated with a node.

11. The system of claim 9, wherein the aggregation technique is a mean aggregation technique, and wherein the mean aggregation technique identifies a mean value of nodes in a k-step neighborhood associated with a node.

12. The system of claim 9, wherein the at least one processor is further programmed or configured to, in response to a new entity being added to the network:
generate a new entity node of the plurality of nodes of the knowledge graph associated with the new entity;
generate at least one new edge of the plurality of edges of the knowledge graph, wherein the at least one new edge connects the new entity node to at least one other node of the plurality of nodes;
generate a default embedding for the new entity node;
update the embedding of the new entity node while holding the embeddings of the plurality of non-entity nodes static, wherein, when updating the embedding of the new entity node, the at least one processor is programmed or configured to:
update the embedding of the new entity node using the aggregation technique to identify a value of entity nodes in a k-step neighborhood associated with the new entity node; and
re-execute the at least one classification machine learning model based at least partially on the updated embedding of the new entity node.

13. The system of claim 9, wherein the at least one processor is further programmed or configured to, in response to an entity being removed from the network:
remove a first entity node from the knowledge graph associated with the entity removed from the network;
identify a second entity node previously connected to the first entity node in the knowledge graph;
update an embedding of the second entity node while holding the embeddings of the plurality of non-entity nodes static, wherein, when updating the embedding of the second entity node, the at least one processor is programmed or configured to:
update the embedding of the second entity node using the aggregation technique to identify a value of entity nodes in a k-step neighborhood associated with the second entity node; and
re-execute the at least one classification machine learning model based at least partially on the updated embedding of the second entity node.

14. The system of claim 8, wherein, when generating the knowledge graph, the at least one processor is further programmed or configured to:
generate at least one middle attribute node of the plurality of nodes associated with a middle subset of values for the at least one attribute, based on the distribution of values; and
wherein each entity node of the plurality of entity nodes is connected, for each attribute of the at least one attribute, to a lower attribute node, a middle attribute node, or a higher attribute node for the attribute, based on the transaction data.

15. A computer program product comprising at least one non-transitory computer-readable medium comprising one or more instructions that, when executed by at least one processor, cause the at least one processor to:
generate a knowledge graph comprising a plurality of nodes connected by a plurality of edges, based on transaction data of a plurality of entities in a network, wherein the one or more instructions that cause the at least one processor to generate the knowledge graph cause the at least one processor to:
generate a plurality of entity nodes of the plurality of nodes, each entity node of the plurality of entity nodes associated with an entity of the plurality of entities;
determine a distribution of values for at least one attribute of the plurality of entities in the network, based on the transaction data;
generate at least one lower attribute node of the plurality of nodes associated with a lower subset of values for the at least one attribute, based on the distribution of values;
generate at least one higher attribute node of the plurality of nodes associated with a higher subset of values for the at least one attribute, based on the distribution of values; and
generate the plurality of edges, each edge of the plurality of edges connecting two nodes of the plurality of nodes and being associated with a relationship between the two nodes;
initialize embeddings associated with the plurality of nodes with random values;
generate learned representations of the plurality of nodes by repeatedly updating the embeddings associated with the plurality of nodes, wherein the one or more instructions that cause the at least one processor to repeatedly update the embeddings cause the at least one processor to, until convergence of the embeddings on the learned representations:
update the embeddings of the plurality of entity nodes while holding the embeddings of a plurality of non-entity nodes of the plurality of nodes static, the plurality of non-entity nodes comprising a set of the plurality of nodes exclusive of the plurality of entity nodes; and
update the embeddings of the plurality of non-entity nodes while holding the embeddings of the plurality of entity nodes static; and
execute at least one classification machine learning model using the learned representations of the plurality of nodes.

16. The computer program product of claim 15, wherein the one or more instructions that cause the at least one processor to update the embeddings of the plurality of entity nodes cause the at least one processor to:
update an embedding of each entity node of the plurality of entity nodes using an aggregation technique to identify a value of entity nodes in a k-step neighborhood associated with the entity node; and
wherein the one or more instructions that cause the at least one processor to update the embeddings of the plurality of non-entity nodes cause the at least one processor to:
update an embedding of each non-entity node of the plurality of non-entity nodes using the aggregation technique to identify a value of non-entity nodes in a k-step neighborhood associated with the non-entity node.

17. The computer program product of claim 16, wherein the aggregation technique is a pool aggregation technique, and wherein the pool aggregation technique identifies a maximum value of nodes in a k-step neighborhood associated with a node.

18. The computer program product of claim 16, wherein the aggregation technique is a mean aggregation technique, and wherein the mean aggregation technique identifies a mean value of nodes in a k-step neighborhood associated with a node.

19. The computer program product of claim 16, wherein the one or more instructions further cause the at least one processor to, in response to a new entity being added to the network:
generate a new entity node of the plurality of nodes of the knowledge graph associated with the new entity;
generate at least one new edge of the plurality of edges of the knowledge graph, wherein the at least one new edge connects the new entity node to at least one other node of the plurality of nodes;
generate a default embedding for the new entity node;
update the embedding of the new entity node while holding the embeddings of the plurality of non-entity nodes static, wherein the one or more instructions that cause the at least one processor to update the embedding of the new entity node cause the at least one processor to:
update the embedding of the new entity node using the aggregation technique to identify a value of entity nodes in a k-step neighborhood associated with the new entity node; and
re-execute the at least one classification machine learning model based at least partially on the updated embedding of the new entity node.

20. The computer program product of claim 16, wherein the one or more instructions further cause the at least one processor to, in response to an entity being removed from the network:
remove a first entity node from the knowledge graph associated with the entity removed from the network;
identify a second entity node previously connected to the first entity node in the knowledge graph;
update an embedding of the second entity node while holding the embeddings of the plurality of non-entity nodes static, wherein the one or more instructions that cause the at least one processor to update the embedding of the second entity node cause the at least one processor to:
update the embedding of the second entity node using the aggregation technique to identify a value of entity nodes in a k-step neighborhood associated with the second entity node; and
re-execute the at least one classification machine learning model based at least partially on the updated embedding of the second entity node.
